(19) United States
(12) Patent Application Publication
(10) Pub. No.: US 2010/0142740 A1
(43) Pub. Date: Jun. 10, 2010

(54) HEARING AID WIRELESS COMMUNICATION ADAPTOR

(75) Inventor: David Roerup, Frederiksberg C (DK)

Correspondence Address: Vista IP Law Group, LLP (GN Resound), 1885 Lundy Ave. Suite 108, San Jose, CA, 95131, US

(73) Assignee: GN RESOUND A/S, Ballerup (DK)

(21) Appl. No.: 12/596,432

(22) PCT Filed: Apr. 11, 2008
(86) PCT No.: PCT/DK08/00129

§ 371 Date: Feb. 19, 2010

Related U.S. Application Data
(60) Provisional application No. 60/912,082, filed on Apr. 16, 2007.

(30) Foreign Application Priority Data
Apr. 16, 2007 (DK) PA 2007 00556

(51) Int. Cl. H04R 25/00

(52) U.S. Cl. 381/330

(57) ABSTRACT

The present invention relates to a new apparatus for interconnection with a hearing aid, such as a Behind-The-Ear hearing aid. The apparatus provides wireless communication, e.g. in accordance with the Bluetooth standard, between the hearing aid and another device, such as a mobile phone. The apparatus has a housing with a connector mating the hearing aid housing and providing electrical interconnection with the hearing aid. The adaptor further comprises a power supply and is adapted to automatically turn on upon interconnection with the hearing aid.

The present invention relates to an apparatus for interconnection with a hearing aid and providing wireless communication between the hearing aid and another device, such as a mobile phone.

It is well known to use a mobile phone together with a Bluetooth headset. Recently, Bluetooth adaptors for hearing aids have been introduced providing the hearing aid user with numerous possibilities of using her or his hearing aid together with other Bluetooth devices, such as mobile phones, MP3-players, computers, etc.

An example of such a device is disclosed in WO 2006/023920 A1.

It is an object of the present invention to provide an apparatus with improved features for interconnection with a hearing aid for provision of wireless communication between the hearing aid and another device, such as a mobile phone, a MP3-player, a computer, etc.

According to the present invention the above-mentioned and other objects are fulfilled by a hearing aid wireless communication adaptor for interconnection with a hearing aid, the adaptor having a housing with a connector mating the hearing aid housing and providing electrical interconnection with the hearing aid. Preferably, the connector is a Direct Audio Input (DAI) type connector. The adaptor housing further accommodates a hearing aid interface circuit for communication, such as data communication, communication of analog audio signals, etc., with the hearing aid, a wireless transmitter and receiver for wireless communication, a controller for controlling the hearing aid interface circuit and the wireless transmitter and receiver, and a power supply for supplying power to the adaptor. The controller is adapted to automatically turn the adaptor on upon interconnection with the hearing aid.

The automatic turn on of the hearing aid adaptor upon interconnection with the hearing aid relieves the user from the task of manually turning on the adaptor. Turn on of the adaptor brings the adaptor into an idle state in which circuitry in the adaptor is powered so that the adaptor may communicate with another device.

Further, the controller may be adapted to automatically turn the adaptor off upon disconnection from the hearing aid. Turn off of the adaptor brings the adaptor into a standby state in which the power consumption is minimized and only circuitry required for turning the adaptor on upon interconnection with the hearing aid is powered.

In a preferred embodiment, the adaptor housing is adapted for interconnection with a Behind-The-Ear hearing aid.

The adaptor housing may be formed in such a way that the interconnected hearing aid and adaptor has an appearance similar to an existing headset whereby the adaptor serves to camouflage the fact that the user uses a hearing aid. Instead, the hearing aid user appears as a user of a wireless headset which is the latest fashion.

For example, in a preferred embodiment, the adaptor is formed in such a way that the interconnected hearing aid and adaptor has an appearance similar to one of the Jabra® headsets manufactured and marketed by GN Netcom NS, e.g. the Jabra® BT500 headset.

Upon interconnection with the hearing aid, the adaptor may make all the wireless communication functions known from existing headsets available to the hearing aid user. Such functions are for example disclosed in the Jabra® BT500 headset user's manual available from the GN Netcom NS home page http://www.gnnetcom.com.

The wireless adaptor may provide wireless communication at 2.4 GHz. In various embodiments the wireless communications can include standard or nonstandard communications. Some examples of standard wireless communications include, but are not limited to, Bluetooth™, IEEE 802.11(wireless LANs) wi-fi, 802.15(WPANs), 802.16(WiMAX), cellular protocols including, but not limited to CDMA and GSM, ZigBee, and ultra-wideband (UWB) technologies.

In a preferred embodiment, the adaptor performs wireless communication in accordance with the Bluetooth standard, c.f. http://www.bluetooth.com. However, other past and present standards may also be used. It is further contemplated that future versions of these standards and new future standards may be employed without departing from the scope of the present invention.

Various forms of data can be communicated. For example, data such as voice data, streaming audio data, application data, and/or functional parameters, may be communicated according to the present invention.

Bluetooth devices must be paired in order to be able to communicate with each other. Pairing creates a unique and encrypted communication link between two Bluetooth devices so that they may communicate with each other.

It is well known to provide a hearing aid with a directional microphone, or with two microphones providing the hearing aid with directionality, i.e. a directional beam of sound signals within which received sound signals are amplified compared with sound signals arriving from outside the directional beam. For example, the directional beam may point directly in front of the hearing aid user in order to amplify speech from a speaker located in front of the hearing aid user in relation to noise from the environment. However, the small size of hearing aids limits the directionality, i.e. the beam width is wide, that may be made available to the hearing aid user.

Thus, in a preferred embodiment of the present invention, the larger size of the adaptor is exploited for provision of improved directionality to the hearing aid user. For example, an array of microphones may be provided in the adaptor that substitutes the microphone of the hearing aid when the adaptor is interconnected with the hearing aid thereby resulting in a narrow beam width. Alternatively, one or more microphones in the adaptor may co-operate with one or more microphones in the hearing aid for provision of improved directionality to the hearing aid user when the adaptor is interconnected with the hearing aid.

In a preferred embodiment of the adaptor, the power supply is one or more batteries, such as a Lithium-ion polymer battery.

The power supply of the adaptor may automatically be interconnected with the hearing aid circuitry upon interconnection of the adaptor with the hearing aid for power supplying the hearing aid circuitry and relieving the hearing aid battery of this task. In this way, operating time of the hearing aid battery is saved and hearing aid battery exchange or recharge is postponed. Due to the small size of hearing aid batteries, the hearing aid user has to recharge a hearing aid rechargeable battery frequently, typically once a day. Non-rechargeable hearing aid batteries typically need to be exchanged every 4-10 days. Often, it is a cumbersome and tedious task for hearing aid user to handle the small hearing aid batteries and also the small battery door to the battery compartment in the hearing aid housing. Thus, less frequent battery exchange or recharge represents a significant relief to the hearing aid user.

The above and other features and advantages of the present invention will become readily apparent to those skilled in the art by the following detailed description of exemplary embodiments thereof with reference to the attached drawings, in which:

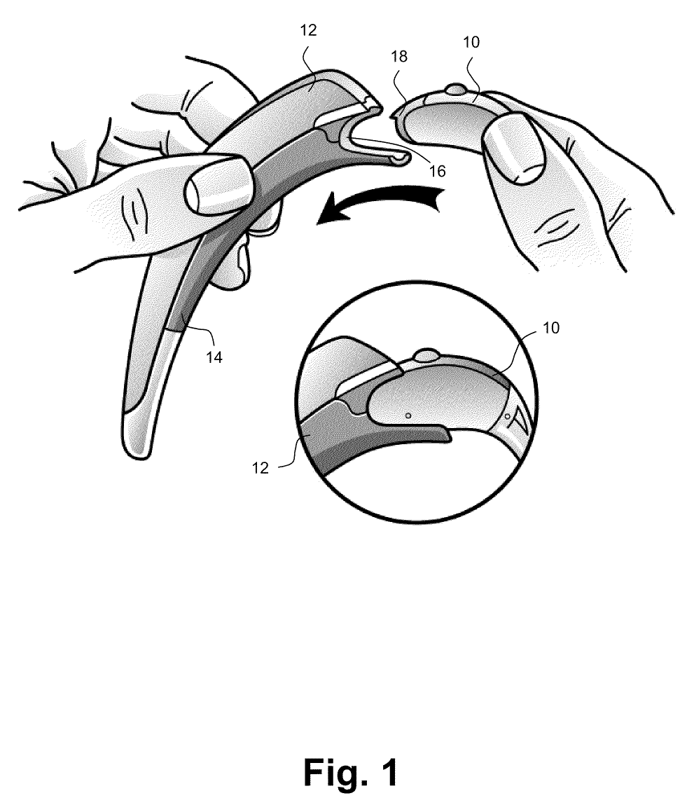

FIG. 1 illustrates in perspective a BTE hearing aid and wireless communication adaptor according to an embodiment of the present invention,

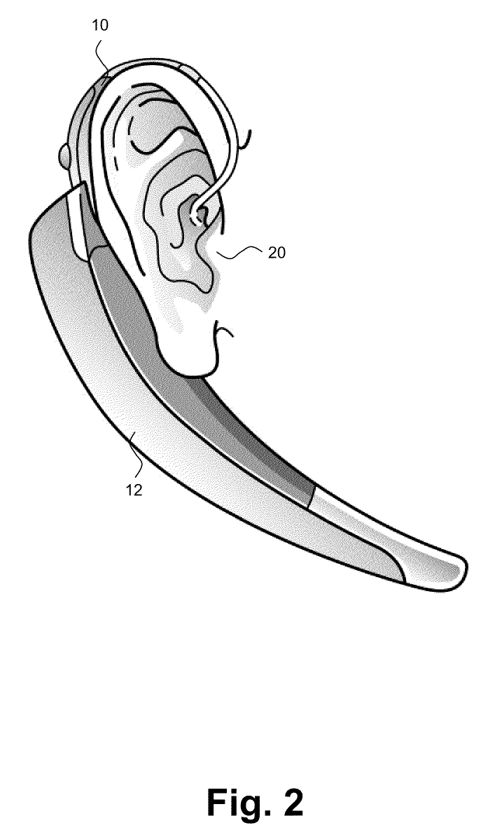

FIG. 2 illustrates in perspective an interconnected BTE hearing aid and wireless communication adaptor according to an embodiment of the present invention worn by a user,

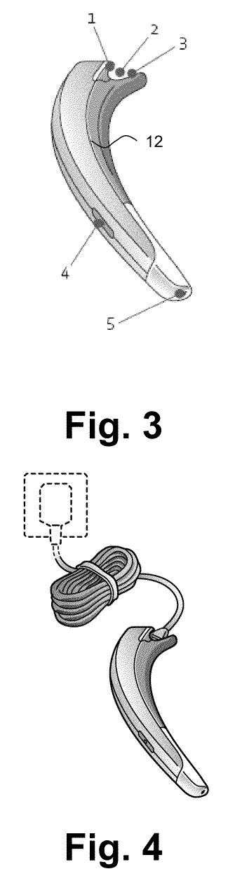

FIG. 3 illustrates in perspective a wireless communication adaptor according to an embodiment of the present invention,

FIG. 4 illustrates in perspective a charging configuration of a wireless communication adaptor according to an embodiment of the present invention,

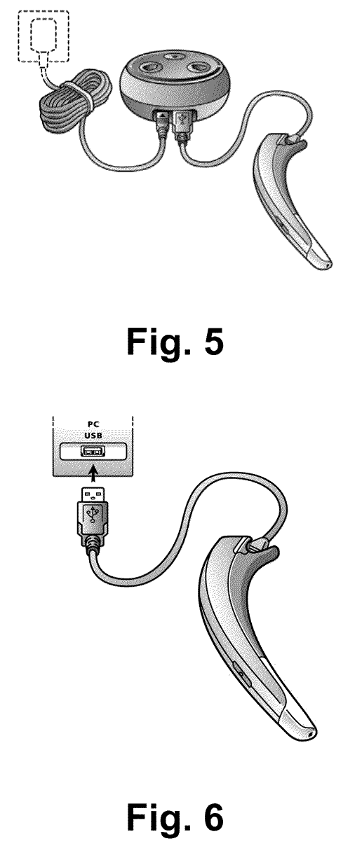

FIG. 5 illustrates in perspective another charging configuration of a wireless communication adaptor according to an embodiment of the present invention,

FIG. 6 illustrates in perspective yet another charging configuration of a wireless communication adaptor according to an embodiment of the present invention,

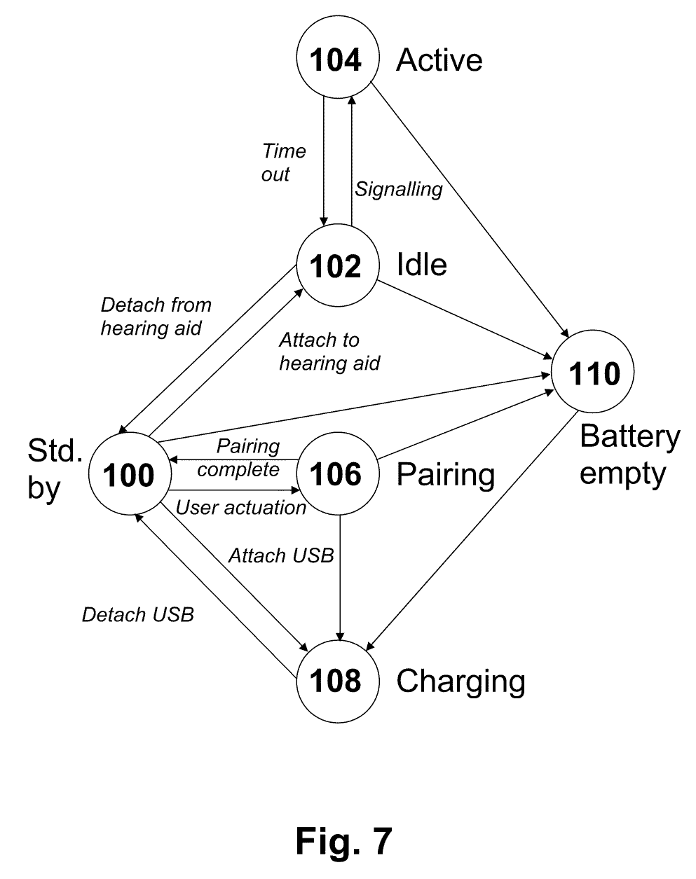

FIG. 7 illustrates a state diagram of a wireless communication adaptor according to an embodiment of the present invention, and

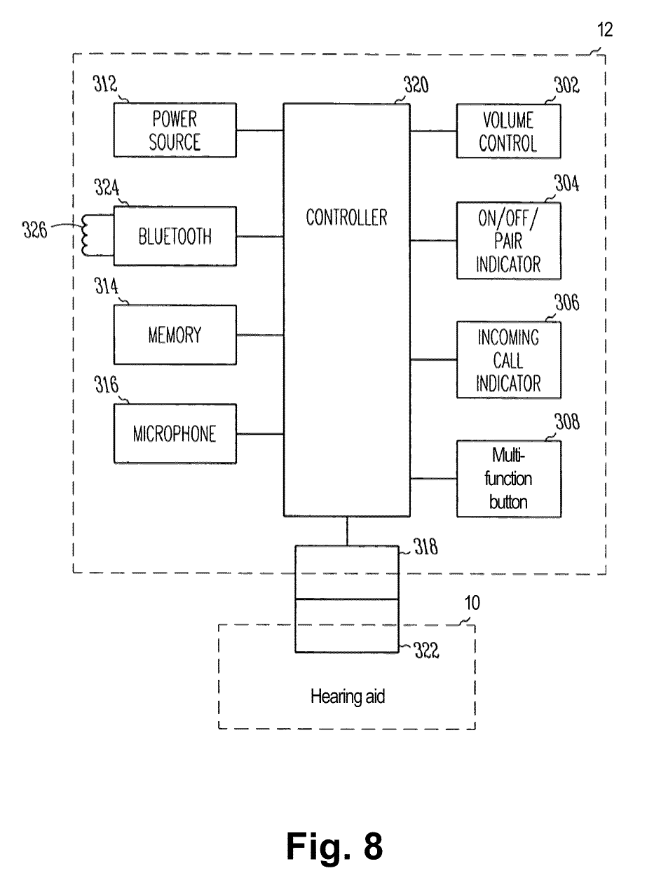

FIG. 8 illustrates a block diagram of an interconnected BTE hearing aid and wireless communication adaptor according to an embodiment of the present invention.

The figures are schematic and simplified for clarity, and they merely show details which are essential to the understanding of the invention, while other details have been left out. Throughout, the same reference numerals are used for identical or corresponding parts.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the concept of the invention to those skilled in the art.

FIG. 1 illustrates in perspective a BTE hearing aid 10 and a hearing aid wireless communication adaptor 12 according to an embodiment of the present invention.

The adaptor 12 has a housing 14 with a connector 16 mating the hearing aid housing 18 and providing electrical interconnection with the hearing aid 10. Preferably, the connector 16 is a DAI type connector.

The adaptor housing 14 further accommodates a hearing aid interface circuit (not visible) for communication with the hearing aid, a wireless transmitter and receiver (not visible) for wireless communication, a controller (not visible) for controlling the hearing aid interface circuit and the wireless transmitter and receiver, and a power supply (not visible) for supplying power to the adaptor. The controller is adapted to automatically turn the hearing adaptor on upon interconnection with the hearing aid.

The automatic turn on of the hearing aid adaptor 12 upon interconnection with the hearing aid 10 relieves the user from the task of manually turning on the adaptor.

The illustrated adaptor 12 is formed in such a way that the interconnected hearing aid and adaptor has an appearance similar to the Jabra® BT500 headset manufactured and marketed by GN Netcom A/S whereby the adaptor serves to camouflage the fact that the user uses a hearing aid. Instead, the hearing aid user appears as a user of a wireless headset which is the latest fashion.

Upon interconnection with the hearing aid, the adaptor makes all the wireless communication functions known from the Jabra® BT500 headset available to the hearing aid user. These functions are disclosed in the Jabra® BT500 headset user's manual available from the GN Netcom A/S home page http://www.gnnetcom.com.

The illustrated adaptor performs wireless communication in accordance with the Bluetooth standard http://www.bluetooth.com. However, other past and present standards may also be used. It is further contemplated that future versions of these standards and new future standards may be employed without departing from the scope of the present invention.

The connector 16 provides for a wired connection in the illustrated embodiments. In one embodiment, the connector 16 includes pads, such as gold plated metallic pads, suitable for forming multiple connections with terminals, such as spring-loaded pin-shaped terminals. However, in additional examples, the connector 16 includes a mechanical lock. In various embodiments, the mechanical lock is releasable. In one example, the mechanical lock is constructed to support the weight of a mating connector and its associated components.

FIG. 2 illustrates an interconnected hearing aid 10 and hearing aid wireless communication adaptor 12 mounted on an ear 20 of a user. The combined hearing aid 10 and wireless communication adaptor 12 can communicate information between the hearing aid 10 and another device (not shown). A variety of other devices can be employed. In one example, the other device is a cellular telephone capable of wireless communication in accordance with the Bluetooth standard.

FIG. 3 illustrates in perspective a wireless communication adaptor with an indicator LED 1, a socket 2 for a hearing aid, a charging socket 3 inside the socket for the hearing aid, a multi-function push button 4, and a microphone 5.

In some embodiments, the electronic circuits of the hearing aid wireless communication adaptor operate independent of notification to a user, but the illustrated embodiment communicates information to the user using the visual indicator 1 and specific sounds.

The adaptor 12 is automatically turned on when the adaptor is interconnected with a hearing aid. In the illustrated embodiment, the connector 16 includes a sense terminal. The hearing aid applies a signal, such as a square wave, on the corresponding sense terminal of the hearing aid connector. At interconnection of the hearing aid and the adaptor, the adaptor senses the square wave on the sense terminal and pulls down the sense terminal thereby decreasing the amplitude of the square wave on the sense terminal so that the hearing aid can sense that it has been connected to the adaptor. The adaptor senses disconnection of the adaptor from the hearing aid by disappearance of the low amplitude square wave, and the hearing aid senses disconnection by increase of the amplitude of the square wave.

Various types of functions can be performed using the multi-function button 4, for example pairing the adaptor with a mobile phone. In the illustrated embodiment, pairing is performed when the adaptor is not connected from the hearing aid and when the adaptor is in proximity to a device or devices to be paired with. For example, in order to pair the adaptor with a mobile phone, the multi-function button 4 is pressed for app. 1 second and pairing starts. The mobile phone is then set to discover the adaptor and the instructions displayed by the mobile phone are followed. During pairing, the LED 1 emits a solid blue light. When the mobile phone has detected the adaptor, the mobile phone typically requires user acceptance of pairing with the adaptor and confirmation with PIN entry “0000” as is well-known in the art of mobile phones with Bluetooth. Upon completion of pairing, the LED 1 emits blue flashes and turns off.

Further, a mobile phone call may be answered or ended by pressing the multi-function button 4 briefly. The adaptor provides an audible indication, such as a click, in response to pressing the multi-function button 4 briefly.

A mobile phone call may be rejected by pressing the multi-function button 4 for approximately 1 second. The adaptor provides an audible indication, such as two clicks, in response to pressing the multi-function button 4 for approximately 1 second.

FIGS. 4-6 illustrate various ways of charging the adaptor 12. In the illustrated embodiment, the charging socket of the adaptor mates a mini-USB connector. FIG. 4 shows the adaptor connected to an AC power adaptor with a USB cable with a mini-USB connector.

FIG. 5 shows the adaptor connected to a USB socket on a charger with a USB/PC cable. The other end of the USB/PC cable is connected to the charging socket on the adaptor.

FIG. 6 shows the adaptor connected to a USB socket on a PC with a USB/PC cable. The other end of the USB/PC cable is connected to the charging socket on the adaptor.

During charging, the LED 1 emits solid yellow light. The LED 1 turns green when the adaptor has been fully charged.

FIG. 7 is a diagram showing the modes or states of an adaptor according to the invention. Most frequently, the adaptor will be in standby 100, idle 102 or active 104 mode. Less frequently, the adaptor will be pairing 106, charging 108 or completely off 110, i.e. the battery is empty.

When the adaptor is not interconnected with a hearing aid, it is turned off, i.e. the adaptor is in its standby mode 100 wherein the power consumption is minimized. For example in the illustrated embodiment, the only circuitry that is powered in the standby mode is the circuitry required for turning the adaptor on upon interconnection with the hearing aid. As previously explained, pressing the multi-function button 4 for app. 1 second brings the adaptor into pairing 106. Upon completion of pairing, the adaptor returns to the standby mode 100. Bluetooth devices must be paired in order to be able to communicate with each other. Pairing creates a unique and encrypted communication link between two Bluetooth devices so that they may communicate with each other.

When the adaptor is interconnected with a hearing aid, the adaptor goes into the idle mode 102 awaiting communication with another device, such as a mobile phone, to take place. The adaptor returns to the standby mode 100 when the adaptor is disconnected from the hearing aid.

The adaptor enters the active mode 104 when signals are transmitted between the adaptor and the other device, for example a call may be received on a mobile phone, or a call may be initiated from the mobile phone. The adaptor returns to the idle mode 102 after a time out period in which no signals have been transmitted between the adaptor and a paired other device.

The battery may run empty in each of the modes 100, 102, 104, and 106. A low battery is indicated by the LED 1 flashing yellow. When the battery is empty, the adaptor enters the battery empty mode 110 in which no circuits of the adaptor receive power. Supplying power to the adaptor through the charging connector 2 brings the adaptor into the charging mode 108 from each of the modes standby 100, pairing 106, and battery empty 110.

As shown in FIG. 8, the adaptor 12 further comprises a hearing aid interface 318 for data communication with the hearing aid 10, a wireless transmitter and receiver 324 for wireless communication, a controller 320 for controlling the hearing aid interface 322 and the wireless transmitter and receiver 324, and a power supply 312 for supplying power to the adaptor. The controller 320 is adapted to automatically turn the hearing adaptor 12 on upon interconnection with the hearing aid 10. In a preferred embodiment, the adaptor 12 has an automatic volume control that elevates sound level and quality to match the environment. If necessary, the volume may be adjusted by adjusting the volume of the other device, e.g. the mobile phone.

1. A hearing aid wireless communication adaptor for interconnection with a hearing aid and having a housing with a connector mating the hearing aid housing and providing electrical interconnection with the hearing aid, the adaptor further comprising a power supply and being adapted to automatically turn on upon interconnection with the hearing aid.

2. An adaptor according to claim 1, wherein the adaptor is further adapted to automatically turn off upon disconnection from the hearing aid.

3. An adaptor according to claim 1 or 2, wherein the adaptor is further adapted to enter a pairing mode when the adaptor is not connected with the hearing aid.

4. An adaptor according to any of the preceding claims, wherein the adaptor housing is adapted for interconnection with a Behind-The-Ear hearing aid.

5. An adaptor according to any of the preceding claims, which is adapted for wireless transmission in accordance with the Bluetooth standard.

6. An adaptor according to any of the preceding claims, further comprising a charging connector.

7. An adaptor according to any of the preceding claims, wherein the adaptor comprises a directional microphone providing the hearing aid audio input signal to the hearing aid when the adaptor is interconnected with the hearing aid.

8. An adaptor according to any of the preceding claims, further comprising an actuator for pairing the adaptor with another device before interconnection of the adaptor with the hearing aid.

9. An adaptor according to any of the preceding claims, wherein the power supply is automatically interconnected with the hearing aid circuitry upon interconnection of the adaptor with the hearing aid for power supplying the hearing aid circuitry.
